(19) United States
(12) Patent Application Publication
(10) Pub. No.: US 2005/0209922 A1
(43) Pub. Date: Sep. 22, 2005

(54) Credit based product marketing method

(76) Inventor: Kurt J. Hofmeister, Dallas, TX (US)

Correspondence Address: KURT J. HOFMEISTER, 4407 SHIRLEY DRIVE, DALLAS, TX, 75229, US

(21) Appl. No.: 11/080,529

(22) Filed: Mar. 15, 2005

Related U.S. Application Data
(60) Provisional application No. 60/554,846, filed on Mar. 19, 2004.

(51) Int. Cl. G06F 17/60; H04K 1/00; H04L 9/00

(52) U.S. Cl. 705/14

(57) ABSTRACT

A credit based marketing process for products and services identifies a particular product or service to be offered to a list of prospective consumers. The list of prospective consumers is subjected to parameters to identify creditworthy prospects by a lending institution or by an independent credit rating agency. Offers to sell the product or service on a credit plan, including the establishment of a credit account, are distributed by direct mail, telemarketing or a computer network, for example. A transaction is completed by notifying a lending institution underwriting the process of a transaction whereby the transaction is funded and an account for the purchaser/consumer is established. The process eliminates or reduces costs to the provider and the lending institution by eliminating unqualified customers, gives the provider a competitive advantage and saves time and effort for the consumer.

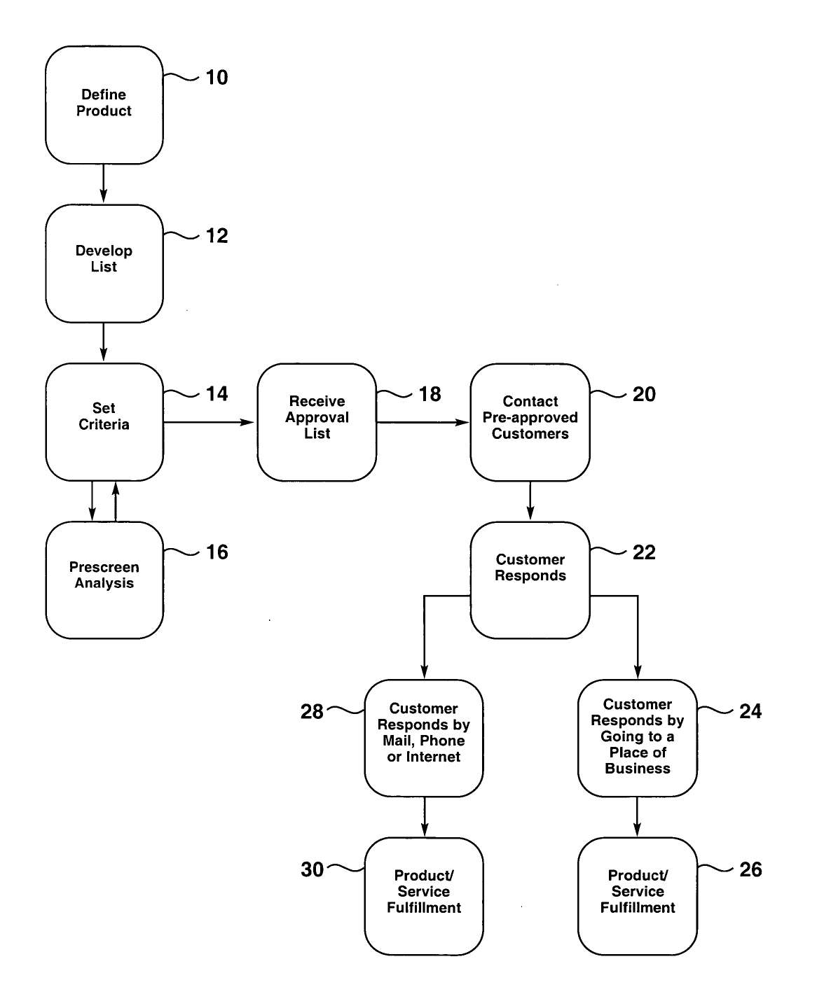

### CROSS REFERENCE TO RELATED APPLICATION

This application claims the benefit of U.S. Provisional Patent Application Ser. No. 60/554,846, filed Mar. 19, 2004.

### BACKGROUND OF THE INVENTION

Credit based economic systems have become relatively highly developed. However, certain problems still exist which inhibit further development of economies which provide credit to both private individual and business end users of products and services. For example, a product or service end-user may not recognize that they qualify for credit based purchasing of relatively expensive, so-called “big ticket” products and services, such as motor vehicles, watercraft, complex electronic equipment, private residence and commercial building improvements and extended travel. Furthermore, product and service end-users may be dissuaded from establishing credit with a lender due to the complexity of the process of applying for and receiving approval for a credit account. Still further, if the consumer chooses to purchase a product or service using an existing credit instrument, such as a general purpose credit card or a product or service provider's private card, then the prospective purchase may “fill-up” the available line of credit on that account, which line of credit may be needed for other purposes.

Another infirmity in well developed credit based economic systems pertains to the fact that traditional product or service provider marketing methods often incur excessive costs on a per unit of sales basis due in part to the lack of credit qualification by a large percentage of those individuals who do respond to direct offers. Still, further, lending institutions often incur excessive costs in establishing new credit accounts in that, for example, a large percentage of new general purpose credit card accounts may not be activated by the prospective account holders, which drives up the average cost of each active account. Still further, with traditional, general purpose credit card systems, the card issuer pays for all marketing of the account. However, with the present invention, a substantial improvement in product marketing is provided by way of reduced costs and expanded access by consumers or other end-users to products and services.

### SUMMARY OF THE INVENTION

The present invention provides a credit based product marketing system and method wherein consumers or end-users of products and services are offered a credit based opportunity to purchase a particular product or service, which product or service may be acquired with a pre-approved credit offer to facilitate the transaction or sale. Accordingly, the consumer or end-user of a product or service effortlessly and unknowingly gains approval to purchase a product or service before the offer is presented. Thus, when the offer is presented to the consumer or end-user, the transaction is much easier for the end-user to consummate, since no credit application process is required, and a competitive advantage is afforded the product or service provider. The inventive credit based marketing process is particularly useful to facilitate the sale of relatively expensive or so called “big ticket” products and services, such as motor vehicles, expensive electronic equipment, recreational products, residential or commercial building improvements or remodeling, travel, including vacation packages, cruise packages and recreation related purchases, such as time-share purchases of real estate or vehicles.

In accordance with an important aspect of the present invention, a product or service provider pre-screens a list of potential customers, consumers or end-users based on predetermined creditworthiness criteria established by the product or service provider and/or by a lending institution participating in the process. The product or service provider then distributes via direct mail, telemarketing or a computer network, for example, offers to the prospective customers to purchase a product or service on a credit basis, which is by making periodic payments to pay for the purchase, for example. Herein, the terms customer, consumer, purchaser and end-user may be used interchangeably.

In accordance with another aspect of the present invention, a method for product or service marketing is provided which permits the targeted potential customer to evaluate the offer to purchase a product or service on a credit or time payment basis wherein the potential customer is not required to apply for a credit account. Thus, the cost (time and/or money) to the customer and the product or service provider to facilitate the transaction is substantially reduced since the individual customer will not be required to apply for credit approval and the product or service provider is not required to spend substantial time and money attempting to complete sales that cannot be completed because of lack of credit approvals.

In accordance with a further aspect of the present invention, a credit based product or service marketing system and method is provided wherein product and service providers are able to obtain a competitive advantage by offering prospective or potential customers a convenient option to purchase a product or service either directly or through a pre-approved credit account. The product or service provider also sets itself apart from competition by the uniqueness of the transaction which also draws attention to the provider's product or service.

In accordance with yet another aspect of the present invention, a credit based product or service marketing method is provided which is advantageous to lending institutions, such as banks and other credit account issuing institutions, since a system and method is provided wherein credit accounts are associated directly with the purchase of a specific product or service and the cost to establish the account may be shared by the product or service provider and the so-called credit card issuer or underwriter. This compares favorably with traditional general purpose credit account issuing processes wherein the account issuer is required to pay for all of the marketing efforts to establish new accounts. Thus, reductions in the costs of marketing the product and the account may be passed on to the consumer by lowering the costs of borrowing or the price of the product or service, or both. Moreover, if the appropriate credit criteria is met, the account issuer may convert the account to a general-purpose credit card account.

The lending institution is further benefited since each account when established starts with a balance due. I.e. The amount of the purchase price of the offered product or service. This means 100% of the new accounts established using this method are “active”. This is a great efficiency when compared to traditionally sourced general-purpose credit accounts which do not reach that level of account activation. I.e. They source and pay for accounts that are never active.

Those skilled in the art will further appreciate the above-mentioned advantages and superior features of the present invention together with other important aspects thereof upon reading the detailed description which follows in conjunction with the drawing.

### BRIEF DESCRIPTION OF THE DRAWING

The drawing FIGURE is a generalized flow diagram illustrating certain steps in the method of the present invention.

### DETAILED DESCRIPTION OF A PREFERRED EMBODIMENT

The present invention fills a need in credit based product and service sales. Consumers or end-users are benefited by reducing the time and uncertainty of making a purchase of a product or service for which the consumer must or chooses to “finance” or borrow funds in order to acquire the product or service. Moreover, product and service providers are benefited by tailoring their offerings of products or services to customers who qualify for time-based or so called credit purchases of such products or services. The transaction process is greatly simplified and the rate of distribution of a product or service is improved.

The benefits to the consumer or end-user of a product or service in accordance with the system and method of the invention are such that a consumer or user, when offered to purchase a particular product item or service item, is aware that they qualify to make the purchase while they are evaluating their desire to acquire the product or service. The offer includes a pre-approval to purchase the product or service on a basis which permits payment in installments over a period of time. The installment payments may not be fixed amounts and the consumer or end-user may make payments in the same manner as with conventional credit card purchases in accordance with account requirements. When the consumer receives the credit based offer to purchase a specific product, they have the opportunity to evaluate the product or service based on price, value or need without the requirement to decide how they will complete the transaction.

In conventional product marketing, if the consumer decides to purchase a particular product or service and is interested in or has a need for time-based payment or financing of the purchase, the consumer then realizes that it may be necessary to apply for credit approval to purchase the product or service either through a general purpose credit issuing institution or the product or service provider's credit system. These conventional credit issuing processes are, of course, time consuming and somewhat cumbersome. Still further, if the consumer chooses to purchase a product or service using an existing credit instrument, such as a general purpose credit card or a product or service provider's private card, then the prospective purchase may “fill-up” the available line of credit on that account, which line of credit may be needed for other purposes. Accordingly, the process of the invention gives the consumer more financial flexibility and saves the consumer time, effort, and potential embarrassment of being disapproved for a credit purchase.

The benefits of the present invention to product and service providers are substantial. Product and service providers are benefited by targeting their offerings of products or services to individuals who have adequate credit to complete the transaction. This targeted approach saves substantial marketing expenses by only soliciting prospective customers that are already credit qualified to make the purchase of the offered product or service. For example, in conventional direct marketing sales processes, a product or service provider identifies a group of individuals who would likely purchase their product or service. The product or service provider then solicits the individual with a direct communication either through direct mail, telemarketing, e-mail or the like, for example. The targeted prospective purchasers then evaluate the offer and decide if they are interested in purchasing the product or service and if a decision is made to purchase, a decision is required as to how payment will be made.

Accordingly, product and service providers, using conventional marketing practices, are required to spend a substantial amount of time and money evaluating a prospective purchaser's credit qualifications and many transactions are never completed because of a lack of creditworthiness. If the product or service provider utilizes the present invention, they are required only to solicit individuals who are prospective purchasers and are pre-qualified to make the purchase on a time payment basis. Thus, the product or service provider's marketing costs per transaction are reduced and the product or service may be marketed at a lower cost to the consumer or end-user. Of course, lower marketing costs are not the only advantages gained by utilizing the process of the present invention, since the product or service provider may also gain a competitive advantage by offering their customers a more convenient option to make the purchase and the provider will also set itself apart from competition by offering a unique sales and financing arrangement which draws attention to the products and/or services of such provider.

The credit based product or service marketing method of the invention provides benefits to lending institutions, such as banks or other financing institutions which issue “credit cards” or the like. By combining the financing of the product or service in the sales process an additional source for new general credit accounts for the lending institution is provided. The lending institution's acquisition cost per account is lowered for reasons that the account activation and marketing costs may be shared with a product or service provider. Moreover, all of the new accounts will have a balance due when they are established. This is important to credit issuing institutions because a large percentage of new general purpose credit accounts, such as conventional credit card accounts, are never activated. This means that individuals who have established an account with a lending institution never use it and the average cost per active account actually established is increased. Furthermore, since a credit account established in accordance with the invention is tied to the purchase of a specific product or service, the cost to establish the sale and the account can be shared by the product or service provider and the credit issuing institution. This is unlike traditional general purpose credit card accounts wherein the credit issuer or lending institution is required to pay for all of the marketing of the account.

Many products or services may be marketed in accordance with the process of the invention. Products such as automobiles, trucks, recreational vehicles, motorcycles, boats, personal watercraft, all-terrain vehicles and the like are typical time payment or credit based purchases. Durable goods, such as clothes washers and dryers, refrigerators, furniture, and expensive electronics, such as computers or television sets, are also typically purchased on a credit or “financed” based transaction wherein the consumer makes full payment for the product or service over an extended period of time. Other transactions which may benefit from the process of the invention may include travel and time-share purchases of real estate and vehicles. Other major transactions from a monetary standpoint may also benefit from the process of the invention. Moreover, although the method may be advantageously employed to market products and services to individual “consumers” or end-users, the process may be implemented for commercial sales or so-called business-to-business transactions.

Traditional marketing methods by way of direct mail, for example, can raise the cost per actual sales of a product or service substantially. For example, assume that a product or service provider solicits individual purchases by direct mail offer to 100,000 potential customers, the costs of which may be $0.65 for each offer, including postage. Typically, one percent of the individuals solicited will respond to the offer. Assuming a response rate of one percent, the cost per response is $65.00 ($0.65/0.01=$65.00). Then assuming that forty percent of the responders do not qualify for credit, the cost per sale has increased to $108.33 ($65.00/(1−0.40)=$108.33).

Conversely, with the credit based product or service marketing method according to the invention and utilizing direct mail, the process first involves pre-screening a list of potential customers for a product or service to identify and eliminate the forty percent discovered after expenses were already incurred according to the conventional process described above. In accordance with the invention, the product or service provider then only direct mails 60,000 solicitations since the forty percent which did not qualify under conventional credit practices have already been eliminated from solicitation. The same costs per solicitation of $0.65 and a response to the solicitation of one percent of all of the prospects solicited provides for the cost per sale to be reduced to $65.00 (0.65/0.01=$65.00). Accordingly, a savings of $43.33 per sale is realized with the process of the invention.

Accounts that never activate drive up the cost of marketing and uses lender resources. A never active account is an account that a customer applies for, the lender sets up the account and sends a card or other method to access the account to the customer and the customer never makes a transaction on the account. Accounts that are not activated do not, of course, generate any revenue for the lender. Accounts that are not activated cost the lender both marketing expense and internal setup costs. Therefore it is in the lender's best interest to minimize the number of never active accounts.

Since consumers do not always activate traditionally sourced general-purpose credit card or store private label card accounts after they obtain the account, such increases the costs of marketing and account setup by a meaningful amount. For example, assume a lender spends, on average, $100 in marketing expenses to solicit a new account and then also spends $30 to establish the account (application processing, credit approval, account setup and sending a card and required account information), which equals $130 for each new account. Assume, for example, that 20% of accounts established never activate. Since never active accounts do not generate any revenue for the lender, the average cost per activated account will increase to $162.50 per activated account. ($130/(1−20)) This is an increase of $32.50 per active account. However, accounts established using the method of the present invention are 100% activated at the time of establishment of the account. This generates a savings of $32.50 per account over accounts sourced using traditional methods.

Referring to the process steps outlined in the drawing figure, in accordance with a preferred embodiment of the invention, the process or method would be initiated by step 10 of defining a product or service to be marketed and the product or service pricing would be set. The product or service provider would also be instrumental in or fully responsible for defining a list of prospective purchasers (customers) of the product or service. Various criteria may be established for screening a list of prospective purchasers based on demographics, including age, general geographic location, post office address within the generalized location, knowledge of the prospective purchasers habits with respect to purchasing goods and services, and other criteria known to those skilled in the art of marketing products and services. Sources for lists of prospective purchasers may be such lists that are either proprietary to the product or service provider or available to the general public. Thus, in step 12 a specific set of criteria or parameters is used to provide a list of prospective purchasers of the specific product or service already defined. This list is typically referred to as a list of “pre-qualified” accounts or account prospects.

Step 14 involves setting certain credit criteria and may be necessary to enlist the participation of a lending institution, such as a bank, finance company, credit union and the like. Such institutions may, and likely will, set their own credit criteria for the process since this entity will serve as the underwriter, assumes the credit risk and will own the credit account. The credit issuing or lending institution may also be a captive finance entity of the product or service provider, of course.

Step 16 in the diagram of the drawing figure may be implemented to perform an analysis of the predetermined list of prospective customers by applying credit criteria established by the lending institution or underwriter. This step may be carried out by an independent entity, such as a credit bureau or creditworthiness establishing institution. In step 18 the lending institution establishes a prospective customer list based on its own screening activities and those of a credit bureau entity, if the latter is used in the process. This new list of prospective customers is considered a “pre-approved” list and an offer made to a prospective customer on this list may be legally binding on the lending institution and/or the product or service provider. This list may also then be presented to an entity such as a marketing or advertising agency, or the product or service provider itself if it provides that function. This final list of pre-approved potential customers or consumers is then used to distribute offers or solicitations, via mail, telemarketing or a computer network, such as the Internet, for example, at step 20 wherein pre-approved prospective customers are contacted with an offer of credit to purchase a specific product or service at a price stated in the offer, typically. The offer or solicitation would also include the required credit terms and conditions and appropriate state and federal disclosures. Accordingly, this process may be handled by a marketing or advertising entity, by the product or service provider or by the lending institution.

In step 22 of the process, the prospective customer responds to the solicitation by telephone, the Internet, mail or by actually traveling to the physical location of the product or service provider, as indicated at step 24. By responding to the solicitation or offer, the customer is also consenting to the credit terms and conditions described in the solicitations or offer. If the potential customer or consumer responds to the solicitation by actually presenting themselves at the “store” of the product or service provider, the product or service provider verifies information provided by the potential customer and forwards the information to the lending institution or underwriter, whereupon an account is established and funded to consummate the sale of the product or service. The product or service fulfillment is accomplished at step 26 on receipt of an order and shipment or transfer of the product, or documentation associated with the service. The process step 26 may, of course, be carried out by the product and service provider directly.

Referring further to the flow diagram, if the prospective customer responds to the solicitation or offer at step 22 by mail, telephone or Internet, as indicated at step 28, this response is also forwarded to the lending institution or underwriter to again validate or verify information and establish the account. By responding to the solicitation or offer, the customer is also consenting to the credit terms and conditions described in the solicitations or offer. The lending institution or underwriter then may send information regarding the transaction, including specifying the product and shipping instructions to a fulfillment center at step 30 and simultaneously funds the sale or purchase. Again, step 30 carried out by the so-called product or service fulfillment center may also be handled directly by the product or service provider.

Those skilled in the art will recognize that a unique and competitive credit based marketing process for products and services is provided by the present invention which may provide significant advantages to product or service marketing entities, to credit issuing institutions, such as banks and other so-called credit card issuers and, of course, to consumers or end-users of products and services which desirably, or based on need, are purchased on a time payment basis or using “credit”.

Although a preferred embodiment of the invention has been described in detail herein, those skilled in the art will recognize that various substitutions and modifications may be carried out without departing from the scope and spirit of the appended claims.

1. A credit based marketing method for a product or service comprising:
defining at least a type of product or service to be marketed;
generating a list of prospective customers for said product or said service based on a first set of parameters;
submitting said list to a lending institution for establishing a second set of parameters with respect to said list to generate a final list;
distributing an offer to make a credit based purchase of said product or said service to prospective customers on said final list;
executing transactions with one or more customers to purchase said product or said service by a provider thereof and establishing a credit account for said customers by said lending institution; and
delivering said product or said service to said customers, respectively.

2. The method set forth in claim 1 including the step of:
submitting said final list to an independent credit rating agency and further establishing said final list based on the parameters defined by the lending institution and information furnished by said credit rating agency prior to distribution of said offers.

3. The method set forth in claim 1 including the step of:
distributing said offers by an independent marketing/advertising entity.

4. The method set forth in claim 1 including the step of:
distributing said offers by one of direct mail, telephone or a computer network.

5. The method set forth in claim 1 including the step of:
funding said provider by said lending institution upon completion of said transactions, respectively.

6. The method set forth in claim 1 including the step of:
delivering said product or said service by a fulfillment center associated with said provider.

7. The method set forth in claim 1 wherein:
said list is developed by said provider.

8. The method set forth in claim 1 wherein:
said lending institution is owned or controlled by said provider.

9. The method set forth in claim 1 including the step of:
converting one or more of said credit accounts to general purpose credit card accounts.

10. A credit based marketing method for a product or service comprising:
defining a product or service to be marketed;
generating a list of prospective customers for said product or said service based on a predetermined set of parameters;
distributing offers to make a credit based purchase of said product or said service to prospective customers on said list via one of direct mail, telephone or a computer network;
verifying responses from said customers; and
executing transactions with said customers to purchase said product or said service by a provider thereof and establishing respective credit accounts for said customers to pay for said purchases by a lending institution.

11. The method set forth in claim 10 including the step of:
submitting said list to said lending institution for defining another set of parameters with respect to said list.

12. The method set forth in claim 11 including the step of:
submitting said list to an independent credit rating agency and establishing a final list based on said set of parameters defined by said lending institution and information received from said credit rating agency prior to distribution of said offers.

13. The method set forth in claim 10 including the step of:
distributing said offers by an independent marketing/advertising entity.

14. The method set forth in claim 10 including the step of:
funding said provider by said lending institution upon completion of said transactions, respectively.

15. The method set forth in claim 10 including the step of:
delivering said product or said service by a fulfillment center associated with said provider.

16. The method set forth in claim 10 wherein:
said list is developed by said provider.

17. The method set forth in claim 10 wherein:
said lending institution is owned or controlled by said provider.

18. The method set forth in claim 10 including the step of:
converting one or more of said credit accounts to general purpose credit card accounts.

19. A credit based marketing method for a product or service comprising:
defining a product or service to be marketed;
generating a list of prospective customers for said product or said service based on a predetermined set of parameters;
submitting said list to a lending institution for establishing a further set of parameters with respect to said list;
distributing offers to make a pre-approved credit based purchase of said product or said service to prospective customers selected from said list via one of direct mail, telephone or a computer network;
verifying responses from said customers; and
executing transactions with said customers to purchase said product or said service by a provider thereof and establishing respective credit accounts for said customers to pay for said purchases by said lending institution.

20. The method set forth in claim 19 including the step of:
submitting said list to an independent credit rating agency and establishing a final list of prospective customers based on said further set of parameters defined by said lending institution and information from said credit rating agency prior to distribution of said offers.

21. The method set forth in claim 19 including the step of:
stating a price for said product or service as part of said offer.

22. The method set forth in claim 19 including the step of:
disclosing required terms and conditions of said transaction as part of said offer.
